(19) United States
(12) Patent Application Publication
(10) Pub. No.: US 2011/0115387 A1
(43) Pub. Date: May 19, 2011

(54) LED LAMP AND PROTECTING CIRCUIT THEREOF

(75) Inventors: CHIN-LONG KU, Tu-Cheng (TW); HUAI-QING ZHENG, Shenzhen City (CN)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/684,900

(22) Filed: Jan. 9, 2010

(30) Foreign Application Priority Data
Nov. 13, 2009 (CN) 200910309721.X

(51) Int. Cl. H05B 39/00; H05B 41/36; H05B 37/02

(52) U.S. Cl. 315/185 R; 315/291; 315/294

(57) ABSTRACT

A protecting circuit for an LED unit includes first, second, third and fourth diodes. A cathode of the second diode couples to an anode of the first diode, and a cathode of the third diode couples to a cathode of the first diode. The fourth diode includes an anode coupling to the anode of the second diode and a cathode coupling to the anode of the third diode. A first junction is formed between the first and second diodes, a second junction is formed between the third and fourth diodes, a third junction is formed between the second and fourth diodes, and a fourth junction is formed between the first and the third diodes. The first and the second junctions are connected to the LED unit. The third and fourth junctions are connected to a power source for supplying electric current to the LED unit.

### BACKGROUND

1. Technical Field

The disclosure generally relates to light emitting diode lamps, and particularly to a protecting circuit of a light emitting diode lamp.

2. Description of Related Art

Recently, light emitting diodes (LEDs) have become widely used in a variety of LED lamps, for example, miner's lamps, street lamps, submarine lamps and stage lamps, for their low power requirement and long lifetime.

It is well known that an LED includes an anode and a cathode for respectively connecting to positive and negative output terminals of a power source to apply electronic current to the LED to generate light. However, if the LED is connected to the power source in reverse, i.e., the anode is connected to the negative output terminal and the cathode is connected to the positive output terminal, no light is produced if the voltage of the power source less than a breakdown voltage of the LED, and alternatively, a large electric current flows through the LED to cause the LED to be damaged when the voltage of the power source exceeds the breakdown voltage of the LED.

It is thus desirable to provide an LED lamp with a protecting circuit which can overcome the described limitations.

### BRIEF DESCRIPTION OF THE DRAWINGS

FIG. 1 is a circuit diagram of a light emitting diode (LED) lamp according to an exemplary embodiment of the present invention.

FIG. 2 shows the LED lamp of FIG. 1 connected to a power source.

FIG. 3 is similar to FIG. 2, but shows the LED lamp connected to the power source in reverse.

### DETAILED DESCRIPTION

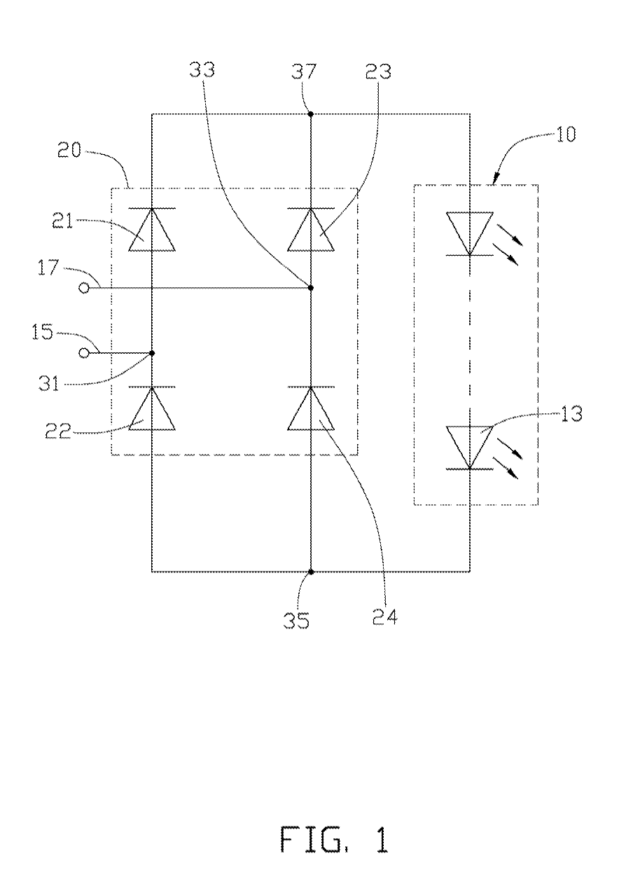

Referring to FIG. 1, a light emitting diode (LED) lamp according to an exemplary embodiment of the disclosure includes an LED unit 10 and a protecting circuit 20 for protecting the LED unit 10 from being damaged.

The protecting circuit 20 is a bridge circuit, and is constructed from four diodes, which includes a first diode 21, a second diode 22, a third diode 23 and a fourth diode 24. The first diode 21 and the second diode 22 are connected in series with an anode of the first diode 21 coupled to a cathode of the second diode 22. A first junction 31 is formed between the first diode 21 and the second diode 22. The third diode 23 and the fourth diode 24 are connected in series with an anode of the third diode 23 coupled to a cathode of the fourth diode 24. A second junction 33 is formed between the third diode 23 and the fourth diode 24. A first terminal 15 is connected to the first junction 31, and a second terminal 17 is connected to the second junction 33. The first terminal 15 and the second terminal 17 function as outer terminals of the LED lamp to connect the LED lamp to a power source.

The first and second diodes 21, 22 connected in series, and the third and fourth diodes 23, 24 connected in series are connected in parallel. An anode of the second diode 22 is coupled to an anode of the fourth diode 24, and a cathode of the first diode 21 is coupled to a cathode of the third diode 23. A third junction 35 is formed between the second diode 22 and the fourth diode 24, and a fourth junction 37 is formed between the first diode 21 and the third diode 23.

The LED unit 10 includes a plurality of LEDs 13 connected in series. The number of the LEDs 13 can be changed according to need. The LED unit 10 is arranged between the third junction 35 and the fourth junction 37 of the protecting circuit 20. In this embodiment, a positive electrode of the LED unit 10 is coupled to the fourth junction 37, and a negative electrode of the LED unit 10 is coupled to the third junction 35 of the protecting circuit 20. Alternatively, the positive electrode of the LED unit 10 can be coupled to the third junction 35, while the negative electrode of the LED unit 10 is coupled to the fourth junction 37 of the protecting circuit 20.

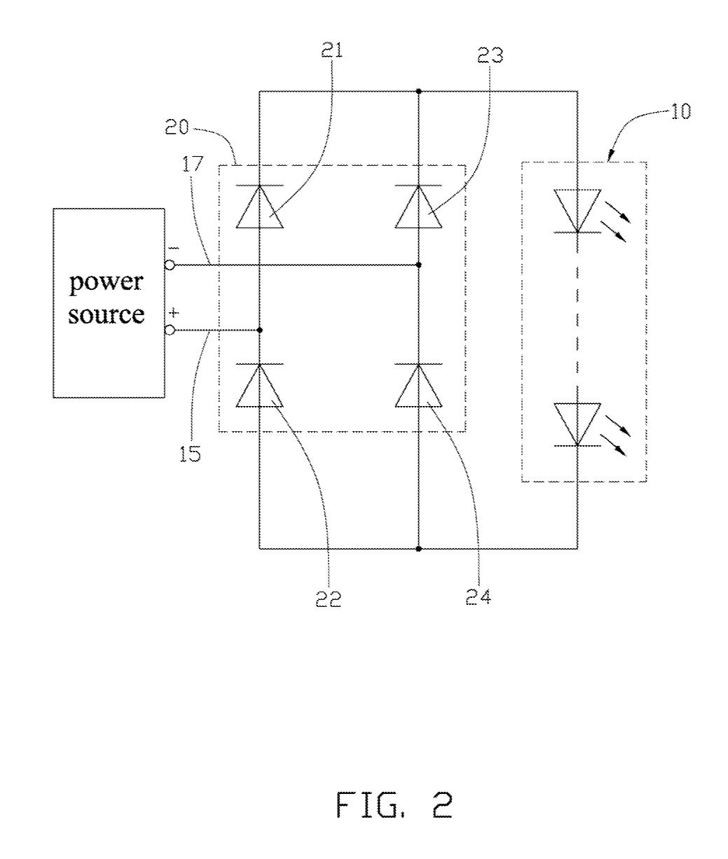

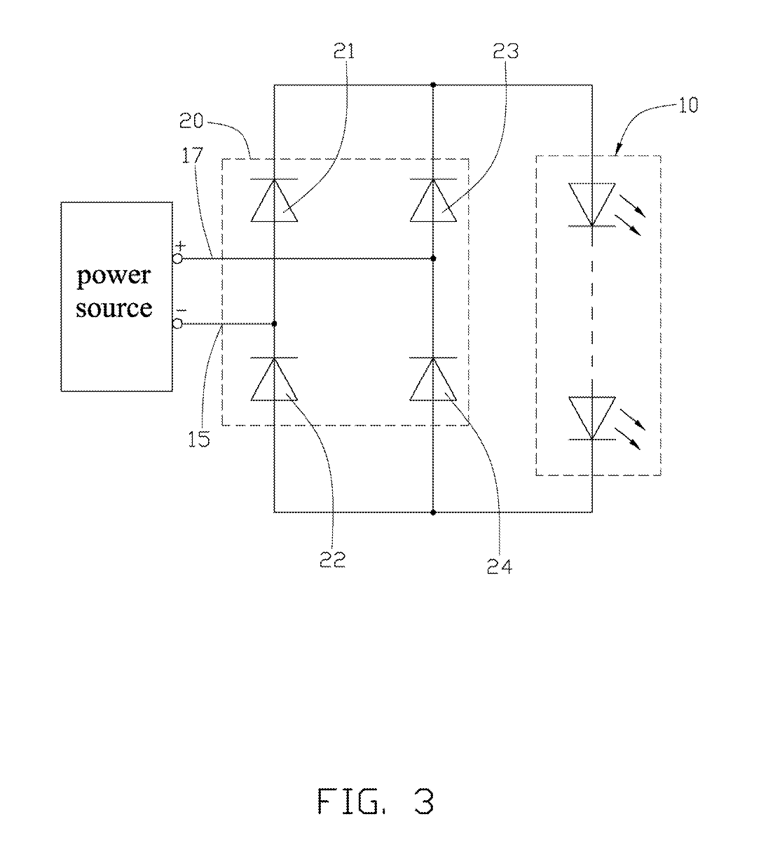

Referring to FIGS. 2 and 3, the LED lamp is coupled to a power source 50 when the LED lamp is in use. Thus an electric current can be supplied to the LED lamp by the power source 50 to cause the LEDs 13 of the LED unit 10 to generate light. Preferably, the power source 50 is a constant current source which can supply constant electric current to the LEDs 13. The power source 50 includes a positive pole and a negative pole for connecting to the first terminal 15 and the second terminal 17 of the LED lamp, respectively.

As shown in FIG. 2, the first terminal 15 of the protecting circuit 20 of the LED lamp is coupled to the positive pole of the power source 50, and the second terminal 17 is coupled to the negative pole of the power source 50. In such a state, the first diode 21 and the fourth diode 24 are turned on, and the second diode 22 and the third diode 23 are turned off. Thus the power source 50, the first diode 21, the LED unit 10, and the fourth diode 24 are connected in series, and cooperatively form a closed loop. Accordingly, electric current can flow through the LED unit 10 to cause the LEDs 13 to emit light.

As shown in FIG. 3, when the LED lamp is connected to the power source 50 in reverse, the first terminal 15 of the protecting circuit 20 of the LED lamp is coupled to the negative pole of the power source, and the second terminal 17 is coupled to the positive pole of the power source 50. In such a state, the second diode 22 and the third diode 23 are turned on, and the first diode 21 and the fourth diode 24 are turned off. Thus the power source 50, the third diode 23, the LED unit 10, and the second diode 22 are connected in series, and cooperatively form a closed loop. Accordingly, electric current can also flow through the LED unit 10 to cause the LEDs 13 to emit light.

Therefore, the LED lamp with the protecting circuit 20 can be connected to the power source 50 in either of the two connecting manners, without the fear that the LEDs 13 may be damaged.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A protecting circuit for protecting an LED, comprising:
a first diode having an anode and a cathode;
a second diode having an anode and a cathode coupling to the anode of the first diode;
a third diode having an anode and a cathode coupling to the cathode of the first diode; and
a fourth diode having an anode coupling to the anode of the second diode and a cathode coupling to the anode of the third diode;
wherein a first junction is formed between the first diode and the second diode, a second junction is formed between the third diode and the fourth diode, a third junction is formed between the second diode and the fourth diode, a fourth junction is formed between the first diode and the third diode, the first junction and the second junction are adapted for connecting to the LED, and the third junction and the fourth junction are adapted for connecting to a power source for supplying electric current to the LED.

2. An LED lamp, comprising:
an LED unit; and
a protecting unit coupled to the LED unit, comprising:
a first diode having an anode and a cathode;
a second diode having an anode and a cathode coupling to the anode of the first diode;
a third diode having an anode and a cathode coupling to the cathode of the first diode; and
a fourth diode having an anode coupling to the anode of the second diode and a cathode coupling to the anode of the third diode;
wherein a first junction is formed between the first diode and the second diode, a second junction is formed between the third diode and the fourth diode, a third junction is formed between the second diode and the fourth diode, a fourth junction is formed between the first diode and the third diode, the first junction and the second junction are connected to the LED unit, and the third junction and the fourth junction are adapted for connecting to a power source for supplying electric current to the LED unit.

3. The LED lamp of claim 2, where the LED unit includes a plurality of LEDs connected in series.
